(19) United States
(12) Patent Application Publication
(10) Pub. No.: US 2026/0342739 A1
(43) Pub. Date: Oct. 29, 2026

(54) Network System, In-Vehicle Apparatus, and Network Management Method

(71) Applicant: Hitachi Astemo, Ltd., Hitachinaka-shi, Ibaraki (JP)

(72) Inventors: Yuji OISHI, Tokyo (JP); Yuta MUTO, Tokyo (JP); Nodoka MIMURA, Tokyo (JP); Koji MAEDA, Hitachinaka (JP); Takashi MURAKAMI, Hitachinaka (JP)

(21) Appl. No.: 19/111,571

(22) PCT Filed: Aug. 7, 2023
(86) PCT No.: PCT/JP2023/028821

§ 371 Date: Mar. 13, 2025

(30) Foreign Application Priority Data
Nov. 24, 2022 (JP) 2022-187538

(51) Int. Cl. H04L 47/80; H04L 41/12

(52) U.S. Cl. CPC H04L 47/803; H04L 41/12

(57) ABSTRACT

An object of the present invention is to provide a network system and a network management method capable of placing an application in consideration of arithmetic resources of respective arithmetic devices existing on a network and communication resources between the arithmetic devices. For this purpose, the present invention includes a communication path selection unit 25 that selects a communication path of an application when the application is placed in each arithmetic device in an application placement destination arithmetic device candidate list 90, based on topology information indicating a communication connection relationship of the plurality of arithmetic devices 3 and 9 and creates a communication path candidate list 110, a performance verification unit 26 that verifies whether a communication requirements 64 is satisfied in each communication path in the communication path candidate list 110 based on the communication performance information and the communication requirements 64, and a setting application unit 27 that places the application in an arithmetic device corresponding to the communication path having the communication requirements 64 verified to be satisfied by the performance verification unit 26 among the arithmetic devices in the application placement destination arithmetic device candidate list 90.

### TECHNICAL FIELD

The present invention relates to a network system and a network management method for placing an application in a plurality of arithmetic devices existing on a network.

### BACKGROUND ART

Automatic driving and safe driving support techniques are progressing every day, and will continue to evolve in the future. Carmakers are considering that these technical advances are applied not only to new vehicles but also to sold vehicles. A technique for this purpose includes an Over-the-Air (OTA) update technique.

In the OTA, a new or updated in-vehicle application (hereinafter, it is simply referred to as an application) is distributed from a server such as a cloud to a vehicle via a wireless network. On the vehicle side, the distributed application is developed in, applied to, and executed in a vehicle system.

The vehicle system has a configuration where a plurality of electronic control units (ECUs) is connected by a network. Here, the ECU is used as a generic term of a sensor such as a camera, of an actuator that operates an engine, a steering, and the like, and of a device that performs arithmetic for control. The ECU transmits and receives data via the in-vehicle network, and computes the data with the application to acquire information for controlling the vehicle. A load is applied to the in-vehicle network due to the transmission and reception of data, but a load state of the in-vehicle network varies depending on an placement situation of the application.

Here, in a case where a new application is added by OTA, the vehicle system needs to select an ECU that executes the new application. PTL 1 discloses a method for selecting an ECU that executes an application when the application is added. The in-vehicle system of ECUs capable of installing additional applications acquired by an application acquisition unit includes a request designation unit, a resource designation unit, and a selection unit. The request designating unit designates a request resource which is a resource requested by the additional application. The resource designation unit designates a provision resource which is a resource that can be provided by each ECU. The selection unit selects the ECU in which the provision resource satisfies the request resource, as an installation destination of the additional application.

### CITATION LIST

### Patent Literature

PTL 1: JP 2020-86522 A

### SUMMARY OF INVENTION

### Technical Problem

In the invention described in PTL 1, the ECU which is an application placement destination can be selected based on the arithmetic resource of the ECU, but the application placement cannot be performed in consideration of a communication resource between the ECUs such as the load situation of the in-vehicle network.

The present invention has been made in view of the above problems, and an object of the present invention is to provide a network system and a network management method capable of placing applications in consideration of arithmetic resources of respective arithmetic devices existing on a network and communication resources between the arithmetic devices.

### Solution to Problem

In order to solve the above object, the present invention provides a network system where an application is placed in any of a plurality of arithmetic devices existing on a network to satisfy execution requirements of the application, the network system including an application requirement holding unit that holds the execution requirements and a communication requirements of the application, an available resource information holding unit that holds available resource information about the plurality of arithmetic devices, an application placement selection unit that selects an arithmetic device capable of executing the application among the plurality of arithmetic devices based on the execution requirements and the available resource information, and creates an application placement destination arithmetic device candidate list, a topology information holding unit that holds topology information indicating a communication connection relationship of the plurality of arithmetic devices, a communication performance information holding unit that holds communication performance information about links of the network, a communication path selection unit that selects a communication path of the application in a case where the application is placed in each arithmetic device in the application placement destination arithmetic device candidate list and creates a communication path candidate list based on the topology information, a performance verification unit that verifies whether the communication requirements are satisfied in each communication path in the communication path candidate list based on the communication performance information and the communication requirements, and a setting application unit that places the application in an arithmetic device corresponding to a communication path having the communication requirements verified to be satisfied by the performance verification unit among the arithmetic devices in the application placement destination arithmetic device candidate list.

Further, the present invention provides a network management method for placing an application in any one of a plurality of arithmetic devices existing on a network to satisfy execution requirements of the application, the network management method including holding the execution requirements and a communication requirements of the application, holding available resource information about the plurality of arithmetic devices, selecting an arithmetic device capable of executing the application among the plurality of arithmetic devices based on the execution requirements and the available resource information, and creating an application placement destination arithmetic device candidate list, holding topology information indicating a communication connection relationship of the plurality of arithmetic devices, holding communication performance information about links of the network, selecting a communication path of the application in a case where the application is placed in each arithmetic device in the application placement destination arithmetic device candidate list and creating a communication path candidate list based on the topology information, verifying whether the communication requirements are satisfied in each communication path in the communication path candidate list based on the communication performance information and the communication requirements, and placing the application in an arithmetic device corresponding to a communication path having the communication requirements verified to be satisfied in the verification of the performance among the arithmetic devices in the application placement destination arithmetic device candidate list.

### Advantageous Effects of Invention

According to the present invention, when an application is placed in any of the plurality of arithmetic devices existing on the network, the execution performance and the communication performance of the application can be secured by considering arithmetic resources of the arithmetic devices and communication resources between the arithmetic devices. Thus, the application can be executed stably.

### BRIEF DESCRIPTION OF DRAWINGS

FIG. 1 is a diagram of an electric and electronic architecture of an in-vehicle apparatus having an in-vehicle network system of the present invention.

FIG. 2 is a hardware configuration diagram of a domain electronic control unit (ECU), a zone ECU, a central ECU, and a gateway.

FIG. 3 is a functional block diagram of an in-vehicle network system of the present invention.

FIG. 4 is an in-ECU available resource information table held by an available resource information holding unit.

FIG. 5 illustrates a configuration example of Over-the-Air (OTA) data received by an application requirement holding unit via a telematics control unit (TCU).

FIG. 6 is an application requirement table held by the application requirement holding unit.

FIG. 7 is a topology information table held by a topology information holding unit.

FIG. 8 is an extract of a communication performance information table held by a communication performance information holding unit.

FIG. 9 is a flowchart showing an operation of an application placement selection unit.

FIG. 10 is an application placement destination ECU candidate list output from the application placement selection unit.

FIG. 11 is a flowchart showing an operation of a communication path selection unit.

FIG. 12 is a flowchart showing an example of detailed processing in step S209 in FIG. 11.

FIG. 13 is a flowchart showing an example of detailed processing in step S221 in FIG. 12.

FIG. 14 shows an example of results of executing the processing of FIG. 13 on a network of a zone architecture.

FIG. 15 is an application communication path candidate list output from the communication path selection unit and input to a performance verification unit.

FIG. 16 is a flowchart showing an operation of a performance verification unit.

FIG. 17 is a flowchart showing an example of detailed processing in step S302 in FIG. 16.

FIG. 18 is a flowchart showing an example of detailed processing in step S303 in FIG. 16.

FIG. 19 is a flowchart showing an example of detailed processing in step S305 in FIG. 16.

FIG. 20 is a communication path list output from the performance verification unit and input to a setting application unit.

FIG. 21 is a flowchart showing an operation of the setting application unit.

FIG. 22 illustrates a configuration example of a communication path setting table used by the setting application unit.

FIG. 23 is a configuration diagram of the performance verification unit according to a second embodiment.

FIG. 24 is a flowchart showing an operation in step S305 in FIG. 16 among operations of the performance verification unit in the second embodiment.

FIG. 25 is a functional block diagram of an in-vehicle network system according to a third embodiment.

FIG. 26 is an application requirement table held by the application requirement holding unit according to a fourth embodiment.

FIG. 27 is an application requirement table held by the application requirement holding unit according to the fourth embodiment.

FIG. 28 is an application requirement table held by the application requirement holding unit according to a fifth embodiment.

FIG. 29 is a flowchart showing an operation of a performance verification unit.

### DESCRIPTION OF EMBODIMENTS

Embodiments of the present invention will be described below with reference to the drawings. Note that, in each drawing, the same elements are denoted by the same reference numerals, and redundant description will be omitted as appropriate.

### First Embodiment

An in-vehicle network system according to the first embodiment will be described below with reference to the drawings.

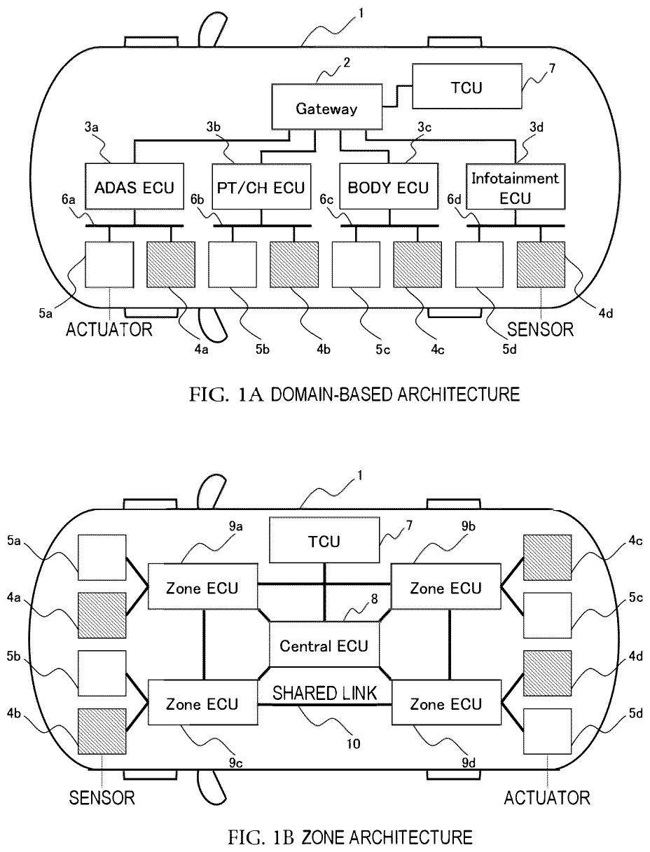

FIG. 1 is a diagram of an electric and electronic architecture of an in-vehicle apparatus having an in-vehicle network system of the present invention. Here, two configurations are taken as a representative electric and electronic architecture, but the application of the present invention is not limited thereto.

FIG. 1(a) is a diagram illustrating a logical configuration of an architecture called a domain-based architecture. This is a system in which in-vehicle electronic control units (ECUs) inside a vehicle 1 are classified into functional categories called domains, and ECUs belonging to one domain are systematically connected. A domain ECU 3 that controls each domain is placed for each domain. Further, the domain ECUs 3 are connected to each other via a gateway 2 in order to perform communication between the domains. The domains include, for example, an advanced driver assistance system (ADAS) domain that manages safe driving assistance, a power train/chassis (PT/CH) domain that controls movements of a vehicle in a front-rear direction and a left-right direction, a BODY domain that controls electric installation equipment such as a power window, and an infotainment domain that controls navigation and audio. An ADAS ECU 3a, a PT/CH ECU 3b, a BODY ECU 3c, and an infotainment ECU 3d (hereinafter collectively represented by 3) are respectively installed in the domains. ECUs 4 and 5, such as sensors 4a to 4d (hereinafter, also collectively represented by 4) and actuators 5a to 5d (hereinafter, also collectively represented by 5), are respectively connected to the domain ECUs 3 by links 6a to 6d (hereinafter, also collectively represented by 6) respective suitable for the domains, such as a controller area network (CAN) and a local interconnect network (LIN). A plurality of the ECUs 4 and 5 may be connected to single link 6. Further, a telematics control unit (TCU) 7 that communicates with a server, a cloud, or the like outside the vehicle via a wireless network is connected to the gateway 2.

The performance and functional requirements of the domain ECUs may vary depending on the domains. For example, hardware having high processing performance is used in the ADAS ECU and the infotainment ECU which treat large-volume data such as video. On the other hand, highly reliable hardware is used in the PT/CH ECU which is directly connected to safety.

FIG. 1(b) is a diagram illustrating a physical configuration of an architecture called a zone architecture. This is a system where the ECUs 4 and 5 are classified according to spatial positions inside the vehicle 1 and are connected to zone ECUs 9a to 9d (hereinafter, also collectively represented by 9) that control the positions. The zone architecture includes one or more zone ECUs 9, a central ECU 8 that is connected to the zone ECUs 9 and executes a plurality of applications across the plurality of domains, the sensors 4 and the actuators 5 that are respectively connected to the zone ECUs 9, and the like. As the name indicates, the zone ECUs 9 are respectively disposed in correspondingly positions (zones) such as front, rear, left, and right positions in the vehicle, and are respectively connected to the sensors 4, the actuators 5, or both of them close to the installation positions. In addition, the zone ECU 9 is connected to another zone ECU 9 by a shared link 10 using a common communication scheme between the domains. As the common communication scheme, a switching network based on Ethernet (registered trademark) is assumed. Although the TCU 7 is connected to the central ECU 8 or any zone ECU 9, FIG. 1(b) illustrates an example in which the TCU 7 is connected to the central ECU 8.

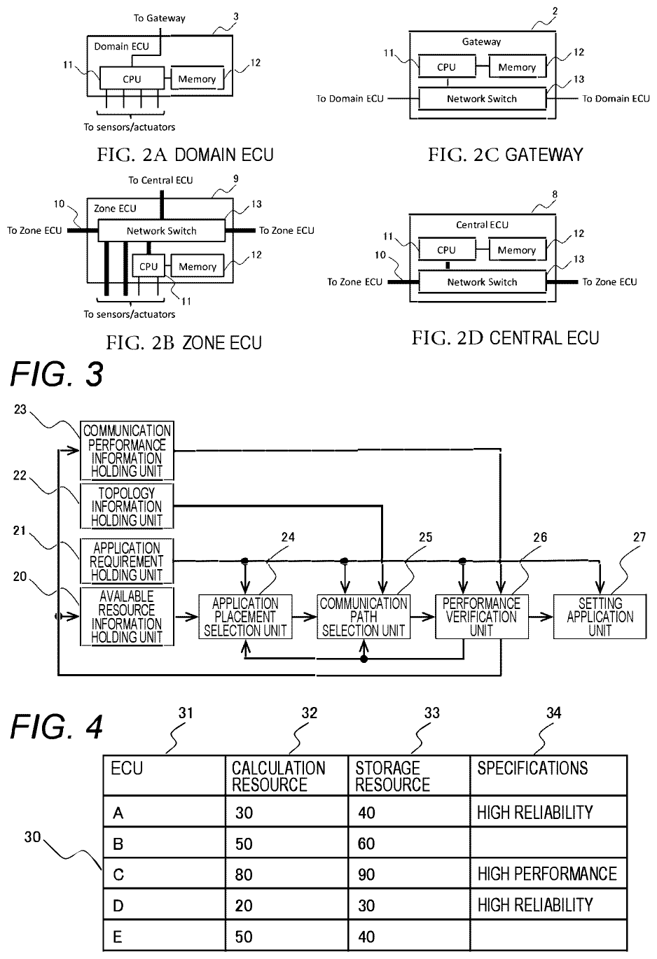

FIG. 2 illustrates hardware configurations of the domain ECU 3, the zone ECU 9, the central ECU 8, and the gateway 2. A thick line in FIG. 2 represents the common communication scheme that is a connection scheme between communication apparatuses 2 in the zone architecture or the domain architecture, and a thin line represents another communication scheme.

FIG. 2(a) illustrates the hardware configuration of the domain ECU 3. The domain ECU 3 includes a central processing unit (CPU) 11 that processes information received from the sensor 4 and the actuator 5 or the gateway 2, and a memory 12 that holds data used by the CPU 11 to do arithmetic. The CPU 11 has a link for connection to the gateway 2 and a link for connection to the sensor 4 and the actuator 5, and the links are extended from the CPU 11.

FIG. 2(b) illustrates the hardware configuration of the zone ECU 9. The zone ECU 9 has a network switch 13 for housing a shared link 10 for connection to another zone ECU 9 or connection to the sensor 4 or the actuator 5. The zone ECU 9 further has the CPU 11 for processing information received from the sensor 4 and the actuator 5 or the shared link 10, and is connected to the network switch 13. The CPU 11 is also connected to the memory 12. When the sensor 4 and the actuator 5 support the common communication scheme, they may be directly connected to the network switch 13. When the sensor 4 and the actuator 5 do not support the common communication scheme, they are connected to the CPU 11, and the scheme can be converted into the common communication scheme.

FIG. 2(c) illustrates a hardware configuration of the gateway 2 in the domain-based architecture. The gateway 2 includes the CPU 11, the memory 12, and the network switch 13 for connection to the domain ECUs 3.

FIG. 2(d) illustrates the hardware configuration of the central ECU 8 in the zone-based architecture. The central ECU 8 has a configuration substantially similar to that of the gateway 2, and includes the CPU 11, the memory 12, and the network switch 13 for connection to the zone ECUs 9.

FIG. 3 is a functional block diagram of the in-vehicle network system of the present invention. Note that the functional blocks may be implemented as independent devices not illustrated in FIG. 1, or may be implemented as software and executed by any ECU in FIG. 1. In the case of implementation as software, the software can be executed without impairing a function in any ECU in FIG. 1, but typically, in order to manage the entire in-vehicle network, the software is assumed to be implemented in the gateway in the case of the domain-based architecture, and implemented in the central ECU in the case of the zone architecture.

The present invention includes functional blocks of an available resource information holding unit 20, an application requirement holding unit 21, a topology information holding unit 22, a communication performance information holding unit 23, an application placement selection unit 24, a communication path selection unit 25, a performance verification unit 26, and a setting application unit 27.

The available resource information holding unit 20 periodically collects and holds resource status inside each ECU, such as, information about a CPU available space and a memory available space.

The application requirement holding unit 21 holds execution requirements regarding an application executed by each ECU in the vehicle. In the application requirement holding unit 21, the requirements of applications pre-installed at the time of shipment of the vehicle are stored at the time of shipment, and the requirements of applications added by Over-the-Air (OTA) are received via the TCU 7 together with OTA data. A specific example of the requirements will be described with reference to FIG. 6.

The topology information holding unit 22 holds topology information indicating a connection relationship of the in-vehicle network.

The communication performance information holding unit 23 holds performance information about communication currently being performed, that is, a communication resource status between the ECUs for each link in the in-vehicle network.

The application placement selection unit 24 determines a placement destination ECU candidate of the application based on each in-ECU resource status acquired from the available resource information holding unit 20 and the execution requirements information about the in-ECU resource (arithmetic resource) of the application acquired from the application requirement holding unit 21.

The communication path selection unit 25 determines communication path candidates for communication performed by the application based on the application placement destination ECU candidates determined by the application placement selection unit 24, the application communication destination information acquired from the application requirement holding unit 21, and the topology information about the in-vehicle network acquired from the topology information holding unit 22.

The Performance Verification Unit 26 Verifies the communication performance of the application against the communication path candidates of the application determined by the communication path selection unit 25 in a case where the communication path candidate is selected based on the communication requirements of the application acquired from the application requirement holding unit 21 and the communication performance information acquired from the communication performance information holding unit 23. As a result of the verification, the application selects one communication path to be actually used from the path candidates satisfying the communication performance.

The setting application unit 27 applies the communication path determined by the performance verification unit 26 to the in-vehicle network. For this purpose, an application data transmission or reception destination address and the like are acquired from the application requirement holding unit 21, and a transfer rule is set in the network switch 13 inside the ECU on the path.

Details of each functional block will be described below.

FIG. 4 is an in-ECU available resource information table 30 held by the available resource information holding unit 20. The in-ECU available resource information table 30 holds information about a calculation resource column 32, a storage resource column 33, and a specification column 34 with respect to an ECU column 31. The specification means characteristics of an ECU, such as high performance or high reliability.

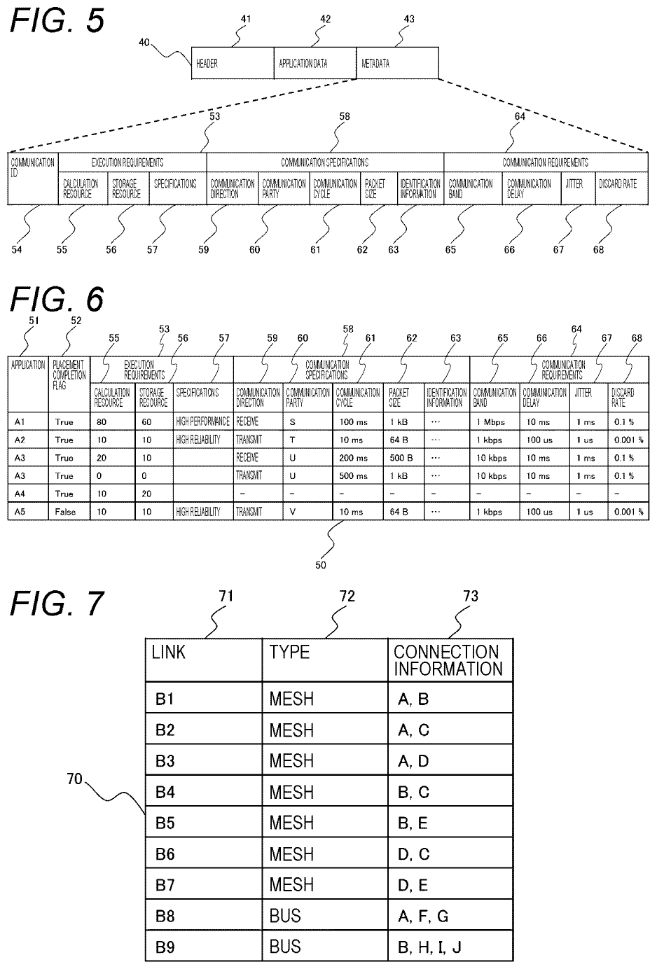

FIG. 5 illustrates a configuration example of OTA data 40 received by the application requirement holding unit 21 via the TCU 7. The OTA data 40 includes a header 41 including an application ID and version information, application data 42 storing a code of an application body in a binary format or the like, and metadata 43 regarding an application referred to in the present invention. The metadata holds execution requirements 53, communication specifications 58, and communication requirements 64 similar to those of the application requirement table 50 shown in FIG. 6 in association with a communication ID 54 which is an identification number of the communication in the application. In a case where the application performs a plurality of communications, the metadata has a plurality of sets of the communication ID, the execution requirements 53, the communication specifications 58, and the communication requirements 64. Details of the execution requirements 53, the communication specifications 58, and the communication requirements 64 are similar to those in FIG. 6, and thus will be described with reference to FIG. 6.

FIG. 6 illustrates the application requirement table 50 held by the application requirement holding unit 21. The application requirement table 50 holds a placement completion flag 52 indicating that an application has been placed in any ECU, the execution requirements 53 holding a requirement regarding the in-ECU resource (arithmetic resource), the communication specifications 58 holding the specifications of the communication between the ECUs, and the communication requirements 64 holding the requirement regarding the communication resource between the ECUs, in association with the application column 51 holding each application ID. The execution requirements 53 include a calculation resource column 55, a storage resource column 56, and a specification column 57. Further, the communication specifications 58 include a communication direction column 59 indicating transmission or reception when viewed from the application, a communication partner column 60 for designating a communication partner of the application, a communication cycle column 61, a packet size column 62, and application identification information 63 that is information for designating an application based on a communication packet, as the application requirement regarding the communication between the ECUs. Examples of the application identification information are a controller area network (CAN) ID of CAN, a transmission source and destination medium access control (MAC) address in Ethernet, transmission source and destination Internet Protocol (IP) addresses in IP, and a transmission source and destination port numbers in transmission control protocol (TCP) or user datagram protocol (UDP). The communication requirements 64 include a communication band column 65, a communication delay column 66, a jitter column 67, and a discard rate column 68. Note that, in a case where a single application performs a plurality of communications, the application expresses the plurality of communications using a plurality of rows like an application A3. Further, in a case where an application does not perform communication, the application can set only the execution requirements like an application A4.

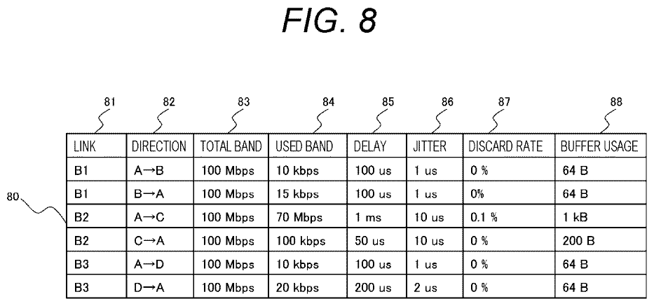

FIG. 7 is a topology information table 70 held by the topology information holding unit 22. The topology information table 70 has a type column 72 and a connection information column 73 for a link column 71 indicating links connecting between the ECUs in the in-vehicle network. The type column 72 describes whether a type of each link is a bus type (a mode in which the plurality of ECUs is connected to one common communication path) or a mesh type (a mode in which one ECU is connected to another ECU on a one-to-one basis). The connection information column 73 holds an ID of an ECU connected to each link.

FIG. 8 illustrates partial extracts of a communication performance information table 80 held by the communication performance information holding unit 23. The communication performance information table 80 has a communication direction 82, a total band column 83, a used band column 84, a delay time column 85, a jitter column 86, a discard rate column 87, and a buffer usage column 88 for a link column 81. The total band column 83 represents a link total band for each link and each communication direction. The used band column 84 represents a band used by an existing application. The delay time column 85 represents a maximum delay time.

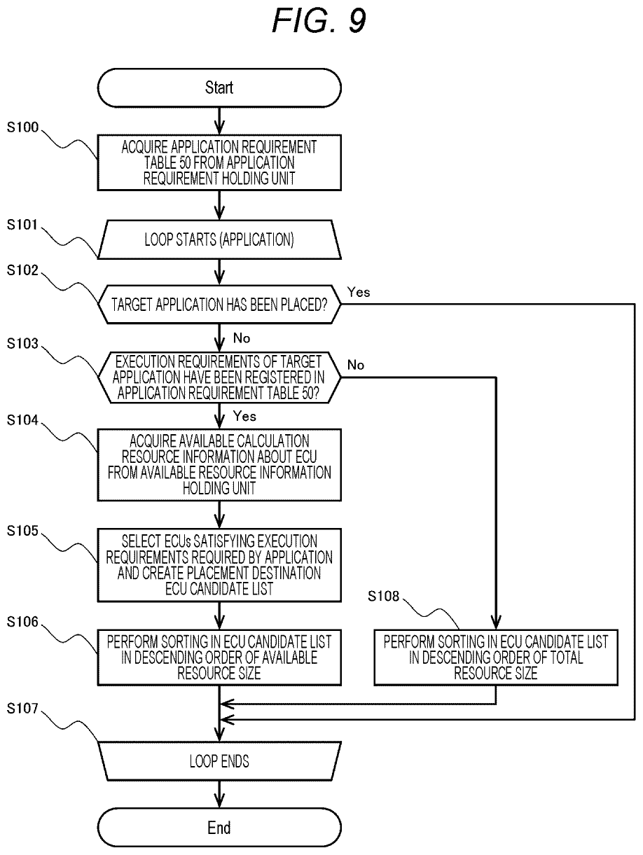

FIG. 9 is a flowchart showing an operation of the application placement selection unit 24. This flowchart is started in response to updating the application requirement table 50 in a manner that an application is added by OTA. First, in step S100, the application requirement table 50 is acquired from the application requirement holding unit 21. Subsequently in S101, the following processing is looped for each application registered in the application requirement table 50. In step S102, the placement completion flag of a target application is checked. In a case where the placement has been completed (Yes), the processing proceeds to the processing of a next application without performing any operation. In a case where the placement has not been completed (No), step S103 and the subsequent steps are executed. In step S103, a checked is made whether the execution requirements of the target application have been registered in the application requirement table 50. In a case where the execution requirement has not been registered (No), a sort is performed in the ECU candidate list defined in advance in step S108 in descending order of total resources to determine ECU candidates of application placement destinations, and the processing proceeds to processing of a next application. In a case where the registration has been completed (Yes), the following processing is performed. In step S104, the in-ECU available resource information table 30 is acquired from the available resource information holding unit 20. In subsequent step S105, among the ECUs in the in-ECU available resource information table 30, ECUs having a calculation resource and a storage resource larger than the calculation resource and storage resource in the application execution requirements and satisfying the specification requested by the application are selected. As a result, the ECUs that satisfy the execution requirements requested by the application are selected, and the placement destination ECU candidate list is created. Then, in step S106, sorting is performed in the ECU candidate list in descending order of the available resources to determine the placement destination ECU candidates of the application. In step S107, the termination of the loop is determined for the applications, and in a case where the processing has been completed for all the applications, this processing is ended.

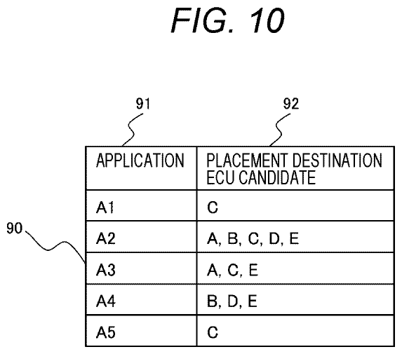

FIG. 10 illustrates an application placement destination ECU candidate list 90 output from the application placement selection unit 24. The application placement destination ECU candidate list 90 holds placement destination ECU candidates 92 for each application column 91. The application placement destination ECU candidate list 90 is a next input to the communication path selection unit 25.

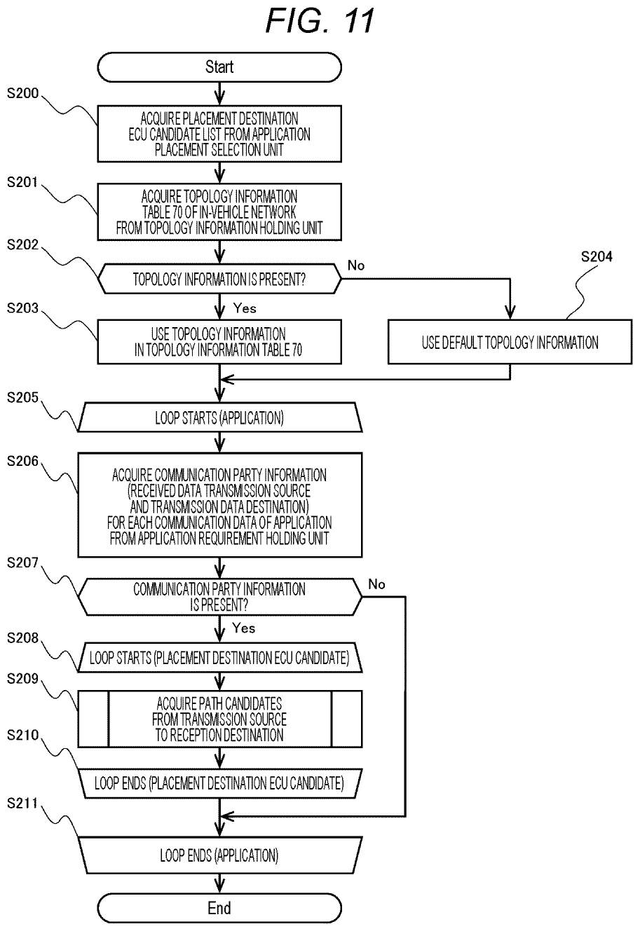

FIG. 11 is a flowchart showing an operation of the communication path selection unit 25. This flowchart is started in response to an input in the application placement destination ECU candidate list 90 from the application placement selection unit 24. First, in step S200, the application placement destination ECU candidate list 90 is acquired from the application placement selection unit 24. In step S201, the topology information table 70 of the in-vehicle network is acquired from the topology information holding unit 22. In step S202, a check is made whether the topology information about the in-vehicle network is included in the topology information table 70. In a case where the topology information is not included (No), default topology information defined in advance in step S204 is used. In a case where the topology information is included in step S202 (Yes), the topology information in the topology information table 70 is used in step S203.

In subsequent step S205, the following loop processing is performed for each application in the application column 91 of the application placement destination ECU candidate list 90. First, in step S206, communication partner information is acquired for each piece of communication data (packet) of an application from the application requirement holding unit 21. Here, the communication partner information collectively refers to a data transmission source in reception data and a data destination in transmission data. In step S207, the communication partner information is examined, and in a case where the information regarding the communication partner is not included (No), a determination is made that communication is not performed, and the processing proceeds to processing regarding a next application. In a case where the information about the communication partner is included in step S207 (Yes), the processing proceeds to step S208 and subsequent steps.

In step S208, a loop for the placement destination ECU candidates 92 in the application placement destination ECU candidate list 90 is started. In step S209, candidates of paths from the transmission source to the reception destination of the data is obtained in separately defined processing. In a case where the processing in S209 has been completed for all the placement destination ECU candidates, the loop regarding the placement destination ECU candidates is ended in S210.

In a case where the processing has been completed for all the applications in the application placement destination ECU candidate list 90, the loop ends in step S211, and the processing of the communication path selection unit 25 ends.

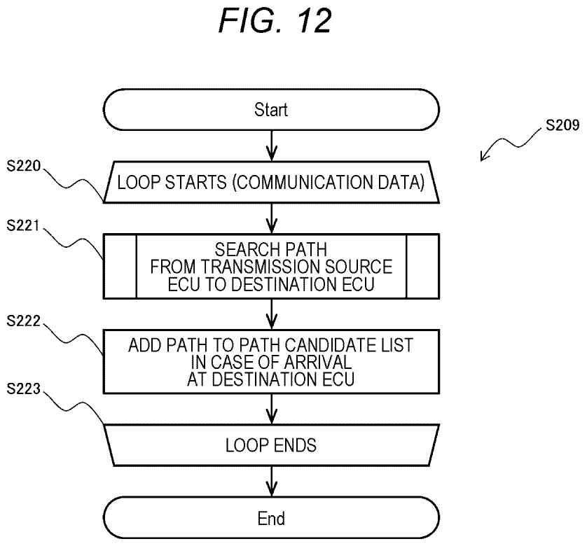

FIG. 12 is a flowchart showing an example of detailed processing in step S209 in FIG. 11. First, in step S220, a loop is started for each communication belonging to an application. In subsequent step S221, a path from the transmission source ECU to the destination ECU is searched in separately defined processing. In step S222, in a case of arrival at the destination ECU, the searched path is added to the path candidate list. In a case where the processing has been completed for all the communication data, the loop ends in step S223, and this processing ends.

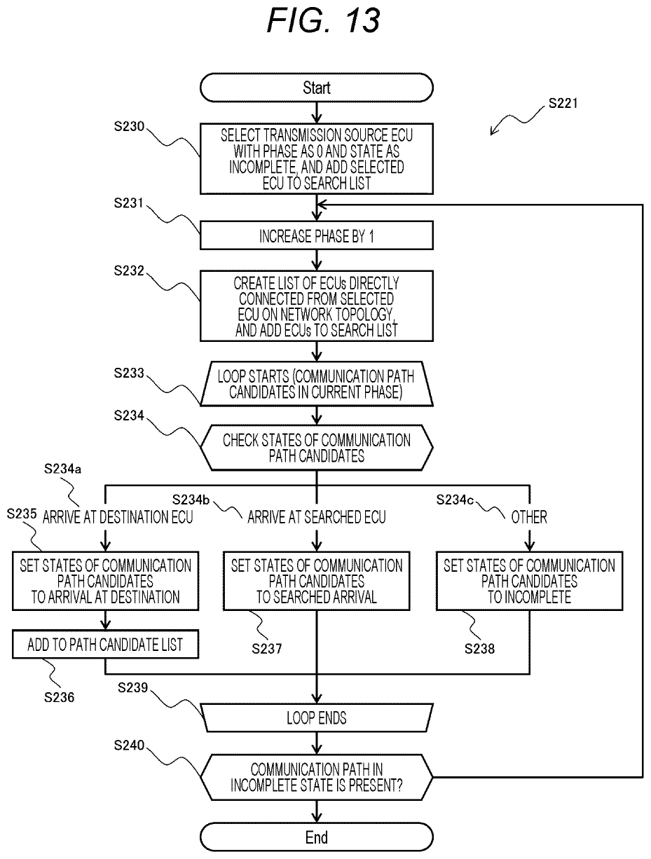

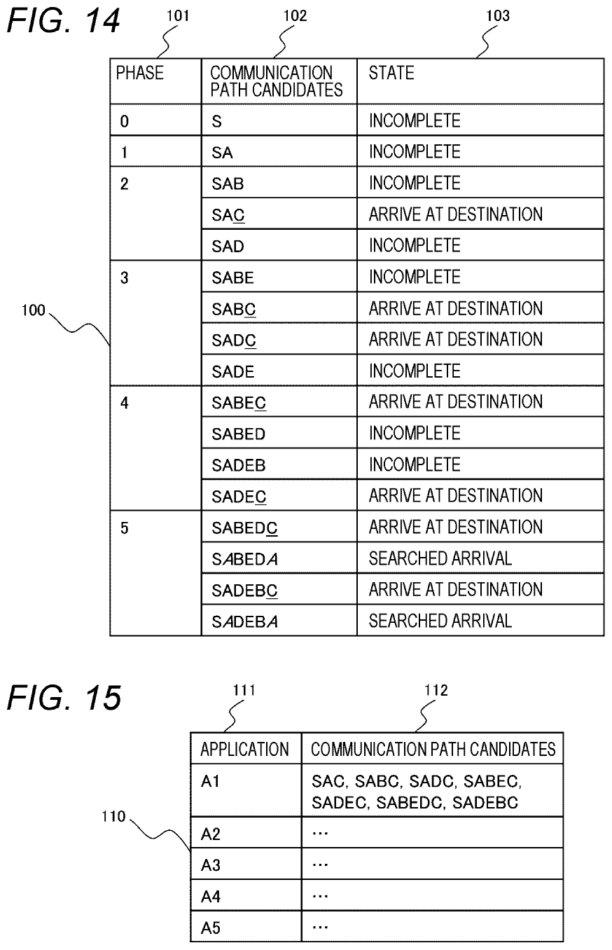

FIG. 13 is a flowchart illustrating an example of detailed processing in step S221 in FIG. 12. Here, the path from the transmission source ECU to the destination ECU is searched in breadth precedence search, but the search may be performed based on another search algorithm such depth precedence search. FIG. 14 illustrates an example of a search list 100 used in the present search processing. The search list 100 has a phase 101 indicating a search stage, a communication path candidate 102 indicating already searched candidates of paths from the transmission source ECU to the destination ECU, and a state 103 indicating a state of the communication path candidate 102.

First, in step S230, a variable “phase” is set to 0, the state is set to incomplete, the transmission source ECU is selected. This transmission source ECU is added as a first entry of the search list. In subsequent step S231, the phase is increased by 1. Next, in step S232, among the communication path candidates 102 whose states indicate incompletion in the search list of a previous phase, an ECU directly connected on the topology is extracted from an ECU at the bottom of the path candidates, and the ECU added to the bottom of the communication path candidate 102 is added to the search list 100 in a current phase.

In step S233, a loop is started for the search list 100 of the current phase created as described above. In step S234, the states of the communication path candidate 102 are checked. First, in a case where the bottom of the communication path candidate 102 is the destination ECU (S234a), the state 103 of the communication path is set to “arrival at destination” in step S235, and this ECU is added to the path candidate list which is the output from the communication path selection unit 25 in step S236. Next, in a case where the bottom of the communication path candidate 102 is a searched ECU in step S234 (S234b), that is, in a case where a plurality of the same ECUs is included in the communication path candidate, the state 103 of the communication path candidate is set to “searched arrival” in step S237. In a case of an ECU other than the searched ECU in step S234 (S234c), the state 103 of the communication path candidate is set to incomplete in step S238. In a case where the processing is completed up to the bottom of the search list of the current phase, the loop ends in step S239.

Finally, in step S240, a check is made whether the communication path candidate 102 whose state indicates incomplete is present in the search list in the current phase. In a case where the communication path candidate 102 whose state indicates incomplete is present, the processing returns to step S231 and continues. In a case where no communication path candidate 102 whose state indicates incomplete is present, that is, in a case where the search for the topology of the in-vehicle network has been completed, this processing ends.

FIG. 14 illustrates an example of results of executing the processing of FIG. 13 on a network of a zone architecture. In the current phase, a list of communication path candidates is created by adding a next reachable ECU to a communication path candidate whose state indicates incomplete in the previous phase. Then, in phase 5, in a case where the state is destination arrival (the portion of ECU C indicated by underline) or search-completed arrival (the portion of ECU A indicated by italics), the search is completed.

FIG. 15 is an application communication path candidate list 110 output from the communication path selection unit 25 and input to the performance verification unit 26. The application communication path candidate list 110 holds communication path candidates 112 for an application column 111.

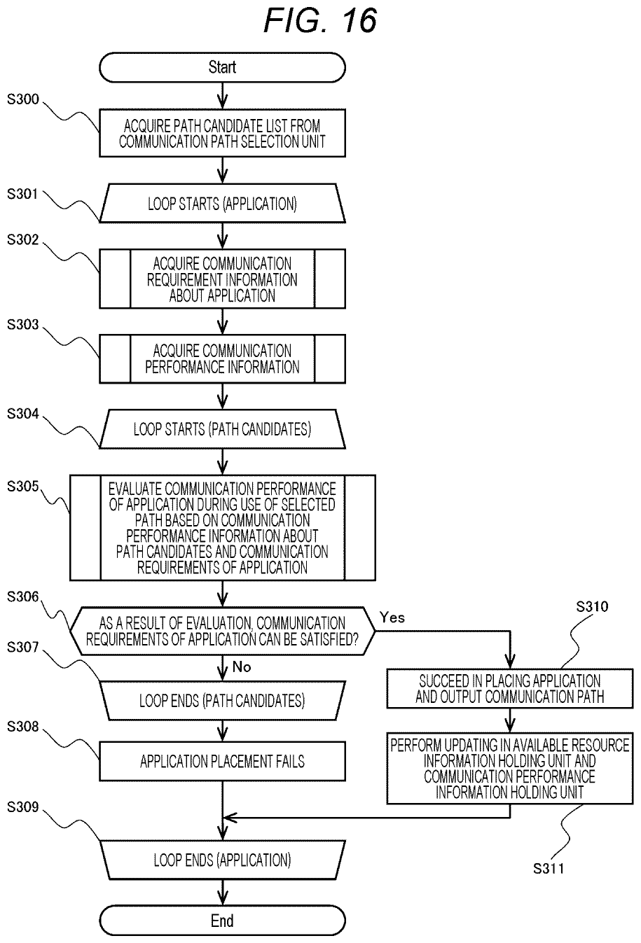

FIG. 16 is a flowchart showing an operation of the performance verification unit 26. First, in step S300, the application communication path candidate list 110 is received from the communication path selection unit 25. Next, in step S301, the loop is executed for the applications described in the communication path candidate list 110. Next, in step S302, communication requirement information about the applications is acquired from the application requirement holding unit 21 in a separately defined procedure. Next, in step S303, communication performance information in each link on the in-vehicle network is acquired from the communication performance information holding unit 23 by following a separately defined procedure. Next, in step S304, the loop is executed for path candidates for the applications described in the communication path candidate list 110. Next, the communication performance of the application at the time of using the selected path is evaluated based on the communication performance information about the path candidates and the communication requirement of the application using a procedure separately defined in step S305. This evaluation result is determined in step S306, and in a case where the communication requirement of the application is not satisfied (No), the loop regarding the path candidate list continues. In a case where a communication path that can satisfy the communication requirement of the application is present in step S306 (Yes), a determination is made that the application is successfully placed in step S310, and the communication path information is output to the setting application unit 27. Subsequently, in step S311, the information about the available resource information holding unit 20 and the communication performance information holding unit 23 is updated. In a case where no communication path that can satisfy the communication requirement of the application is present and the loop ends in step S307, the application placement fails in step S308. Finally, the processing is executed until the loop for each application ends in step S309.

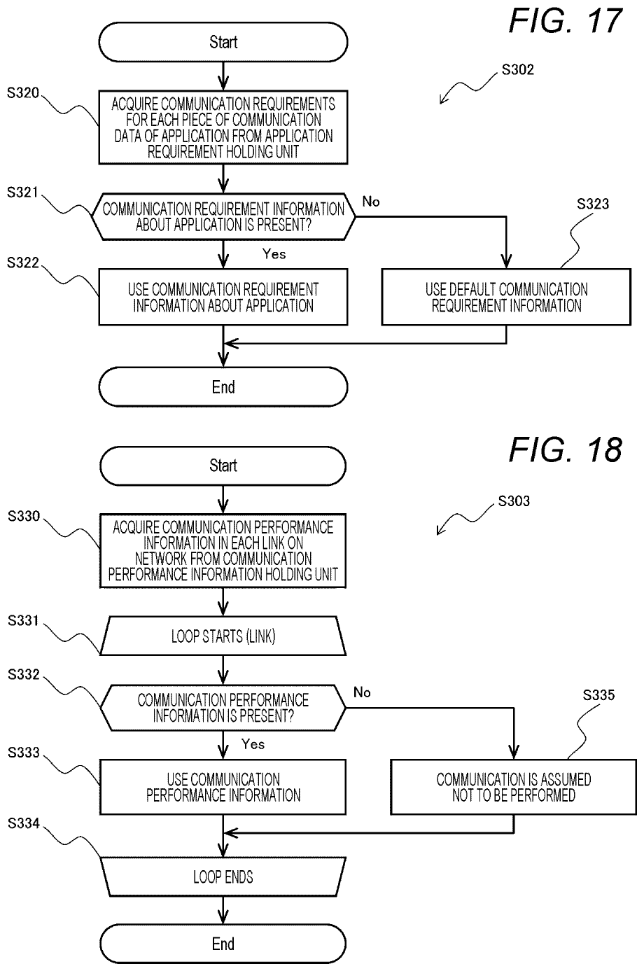

FIG. 17 is a flowchart illustrating an example of detailed processing in step S302 in FIG. 16. This processing is processing for a specific application. First, in step S320, the application requirement holding unit 21 acquires a communication requirement for each piece of communication data of the application. Note that no communication requirement is acquired for an application that does not perform communication. Next, a check is made whether the communication requirement data acquired in step S321 includes the application communication requirement such as a communication band and a delay. In a case where the communication requirement is included (Yes), the application communication requirement acquired from the application requirement holding unit 21 in step S322 is used. In a case where no communication requirement is included in step S321 (No), a default communication requirement defined in advance is used in step S323.

FIG. 18 is a flowchart showing an example of detailed processing in step S303 in FIG. 16. Next, in step S330, communication performance information in each link on the in-vehicle network is acquired from the communication performance information holding unit 23. In next step S331, a loop is started for each link on the in-vehicle network. In step S332, a check is made whether some communication performance information is included in the communication performance information acquired for each link. In a case where the communication performance information is included (Yes), the communication performance information acquired from the communication performance information holding unit 23 is used in step S333. In a case where no communication performance information is included in step S332 (No), it is assumed that communication is not performed on the link in step S335. When the processing is completed for all the links, the loop is ended in step S334.

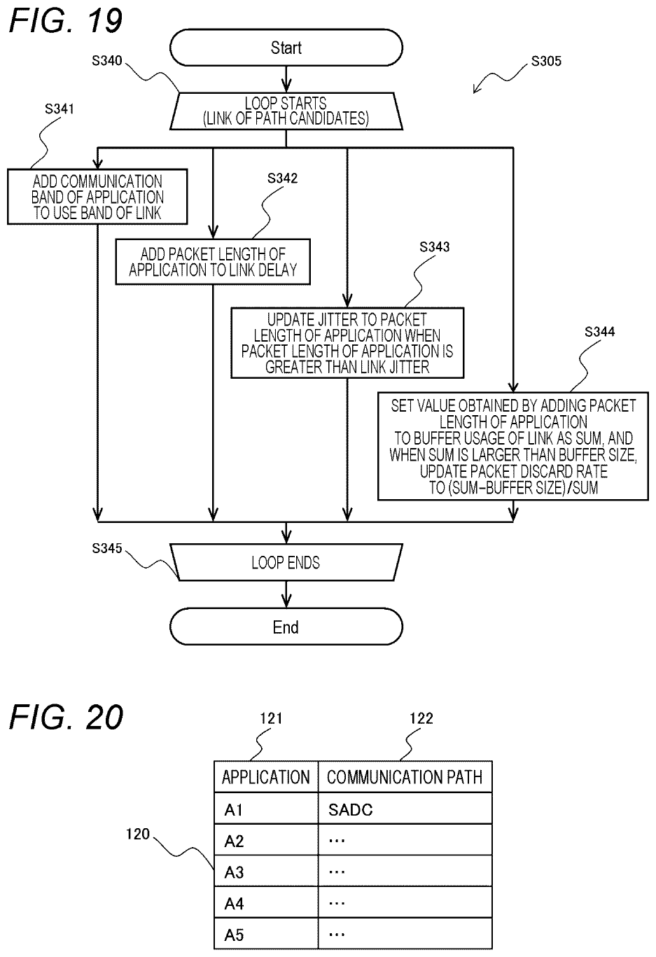

FIG. 19 is a flowchart showing an example of detailed processing in step S305 in FIG. 16. Here, four values of the communication band, the delay, the jitter, and the packet discard rate are obtained by numerical calculation as the communication performance on the link for each application. Since the above-described four values are independently calculable, the following steps are allowed to be performed both in succession and in parallel. First, in step S340, a loop is started for the links respectively constituting the path candidates. Steps S341 to S344 can be executed independently. In step S341, the communication band in a case of adding the application is obtained by adding the communication band of the application to the use band on the link. In step S342, a packet length of the application is added to the delay on the link to obtain a delay in a case of adding the application. The jitter is defined by a maximum value of a packet length transmitted onto the link. The jitter on the link is compared with the packet length of the application. In a case where the packet length of the application is greater than the jitter on the link, the jitter is updated to the packet length of the application in step S343. The packet discard rate is generated due to the overflow of a transmission buffer on the link. In step S344, a value obtained by adding the packet length of the application to a buffer usage on the link is set as SUM, and in a case where the SUM is larger than a buffer size, the packet discard rate is obtained by a formula of (SUM−buffer size)/SUM. In step S345, the loop is ended for the links respectively constituting the path candidates.

FIG. 20 is a communication path list 120 output from the performance verification unit 26 and input to the setting application unit 27. The communication path list 120 holds the communication path 122 selected by the performance verification unit 26 for the application column 121.

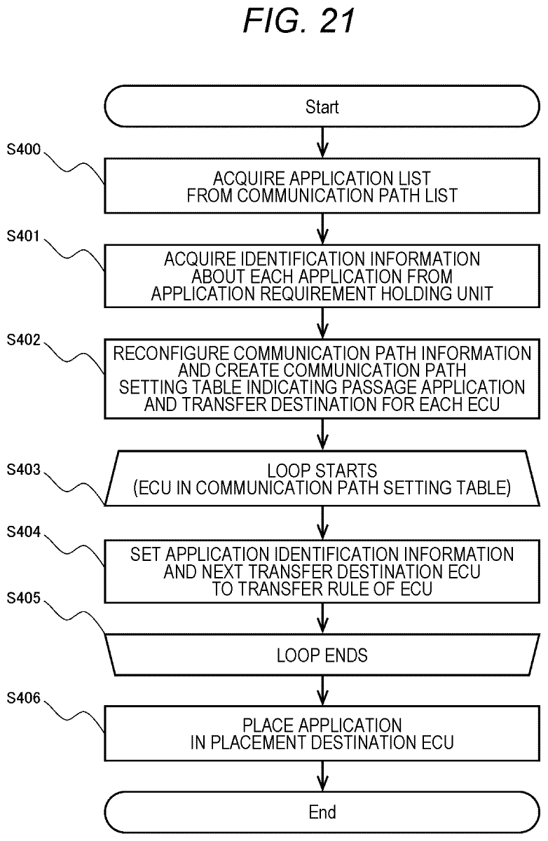

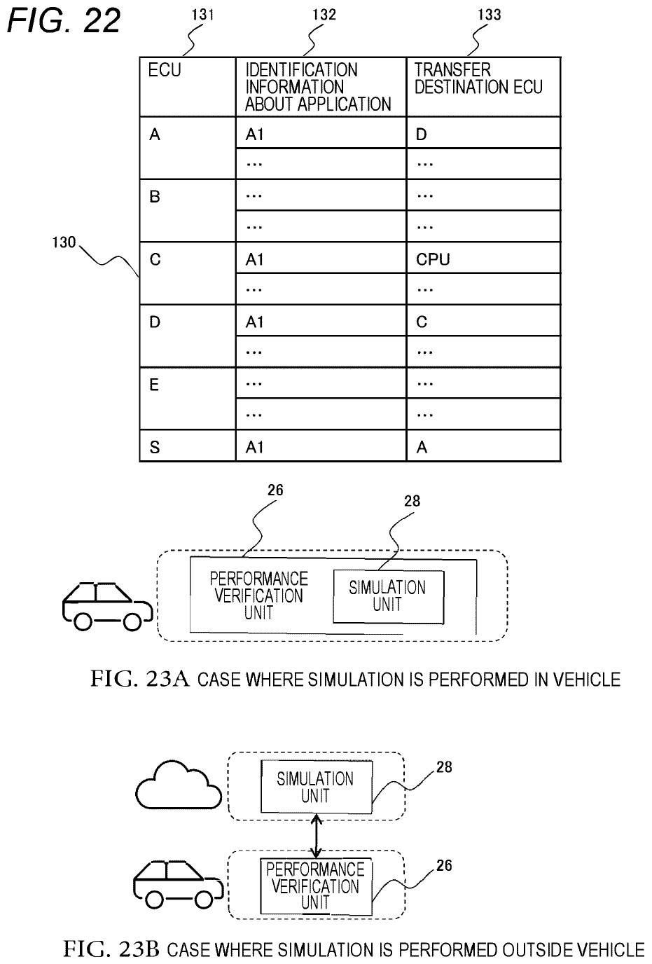

FIG. 21 is a flowchart showing an operation of the setting application unit 27. First, in step S400, included applications are extracted from the communication path list 120 received from the performance verification unit 26, and an application list is created. Next, the identification information about the applications included in the acquired application list in step S401 is acquired from the application requirement holding unit 21. Next, in step S402, the communication path information is reconfigured, and a communication path setting table 130 is generated for each ECU. In the communication path setting table 130, the identification information about the applications through which the communication data passes is associated with next transfer destination ECU of the communication data. A configuration example of the communication path setting table 130 will be described with reference to FIG. 22. In next step S403, the processing in step S404 is looped for each ECU in the communication path setting table 130. In step S404, the application identification information and the next transfer destination ECU are set to each ECU. In step S405, the loop regarding each ECU in the communication path setting table 130 is ended. Finally, the applications included in the application list are placed in the placement destination ECU.s The placement destination ECU is ECU at the head of the transmission data or the bottom of the reception data in the communication path of the application.

FIG. 22 shows a configuration example of the communication path setting table 130 used in the setting application unit 27. The communication path setting table 130 holds application identification information 132 about the application through which the communication data passes and a next transfer destination ECU 133 for the ECU column 131. As for the data received by the application in the application placement destination ECU, the transfer destination is expressed as the CPU.

With the above operation, the in-vehicle network system can place a new application in the ECU upon addition of the application by the OTA in consideration of calculation and storage resources in the ECU and the communication resource between the ECUs. In addition, when an existing application is updated by OTA, the application can be placed with a similar method.

### Summary

In the present embodiment, a network system where an application is placed in any of a plurality of arithmetic devices 3 and 9 existing on a network to satisfy execution requirements 53 of the application, the network system including an application requirement holding unit 21 that holds the execution requirements 53 and a communication requirements 64 of the application, an available resource information holding unit 20 that holds available resource information about the plurality of arithmetic devices 3 and 9, an application placement selection unit 24 that selects an arithmetic device capable of executing the application among the plurality of arithmetic devices 3 and 9 based on the execution requirements 53 and the available resource information and creates an application placement destination arithmetic device candidate list 90, a topology information holding unit 22 that holds topology information indicating a communication connection relationship of the plurality of arithmetic devices 3 and 9, a communication performance information holding unit 23 that holds communication performance information about links of the network, a communication path selection unit 25 that selects a communication path of the application in a case where the application is placed in each arithmetic device in the application placement destination arithmetic device candidate list 90 and creates a communication path candidate list 110 based on the topology information, a performance verification unit 26 that verifies whether the communication requirements 64 are satisfied in each communication path in the communication path candidate list 110 based on the communication performance information and the communication requirements 64, and a setting application unit 27 that places the application in an arithmetic device corresponding to a communication path having the communication requirement 64 verified to be satisfied by the performance verification unit 26 among the arithmetic devices in the application placement destination arithmetic device candidate list 90.

Further, in the present embodiment, a network management method for placing an application in any one of a plurality of arithmetic devices 3 and 9 existing on a network to satisfy execution requirements 53 of the application, the network management method including holding the execution requirements 53 and a communication requirements 64 of the application, holding available resource information about the plurality of arithmetic devices 3 and 9, selecting an arithmetic device capable of executing the application among the plurality of arithmetic devices 3 and 9 based on the execution requirements 53 and the available resource information, and creating an application placement destination arithmetic device candidate list 90, holding topology information indicating a communication connection relationship of the plurality of arithmetic devices 3 and 9, holding communication performance information about links of the network, selecting a communication path of the application in a case where the application is placed in each arithmetic device in the application placement destination arithmetic device candidate list 90 and creating a communication path candidate list 110 based on the topology information, verifying whether the communication requirements 64 is satisfied in each communication path in the communication path candidate list 110 based on the communication performance information and the communication requirements 64, and placing the application in an arithmetic device corresponding to a communication path having communication requirements 64 verified to be satisfied in the verification of the performance among the arithmetic devices in the application placement destination arithmetic device candidate list 90.

According to the present embodiment configured as described above, when an application is placed in any of the plurality of arithmetic devices 3 and 9 existing on the network, the execution performance and the communication performance of the application can be secured by considering the arithmetic resources of the arithmetic devices 3 and 9 and the communication resources between the arithmetic devices, thereby executing the application stably.

Further, the communication requirements 64 and the communication performance information in the present embodiment include any one or more of the communication band, the communication delay, the communication jitter, and the packet discard rate of the application. This makes it possible to define the communication requirements 64 and the communication performance information regarding the application.

Further, the performance verification unit 26 according to the present embodiment verifies whether the communication requirements 64 is satisfied in each communication path in the communication path candidate list 110 using numerical calculation based on the communication performance information and the communication requirements 64. This makes it possible to simply verify whether the communication requirements 64 is satisfied in each communication path in the communication path candidate list 110.

Further, the performance verification unit 26 according to the present embodiment verifies whether the communication requirements 64 is satisfied in each communication path in the communication path candidate list 110 using simulation based on the communication performance information and the communication requirements 64. This makes it possible to accurately verify whether the communication requirements 64 is satisfied in each communication path in the communication path candidate list 110.

Further, in the present embodiment, the metadata 43 input to the network together with the application when the application is placed includes the execution requirements 53 including any one or more of the calculation resource, the storage resource, and the specifications, the communication specifications 58 including any one or more of the communication direction, the communication party, the communication cycle, the communication data size, and the communication identification information, and the communication requirements 64 including any one or more of the communication band, the communication delay, the communication jitter, and the packet discard rate. This makes it possible to define the execution requirements 53, the communication specifications 58, and the communication requirements 64 of the application.

The network in the present embodiment is the in-vehicle network mounted on a vehicle, and the plurality of arithmetic devices 3 and 9 is the plurality of in-vehicle electronic control apparatuses 3 and 9 mounted on the vehicle. This makes it possible to stably execute the newly placed application in the in-vehicle network.

The in-vehicle apparatus in the present embodiment includes the network system. This makes it possible to stably operate the newly placed application in the in-vehicle apparatus.

Further, the communication requirements 64 in the present embodiment include items related to sensor data output from the sensors 4 mounted on the vehicle, control data for controlling the vehicle, and intermediate data acquired during arithmetic for obtaining the control data from the sensor data. This makes it possible to define the communication requirements 64 in accordance with the requirement performance of the in-vehicle apparatus.

### Second Embodiment

In the first embodiment, the communication performance has been estimated using numerical calculation. Although this method is simple because of a small amount of calculation, the accuracy of estimation is low. Therefore, in the second embodiment, as another method, a method for estimating the communication performance using network simulation will be described.

The main configuration and operation flow in the present embodiment are similar to those in the first embodiment. Hereinafter, only differences from the first embodiment will be described.

FIG. 23 is a configuration diagram of the performance verification unit 26 according to the second embodiment. The performance verification unit 26 in the present embodiment is able to have roughly two configurations. FIG. 23(a) is the configuration diagram in a case where simulation is performed in a vehicle. The performance verification unit 26 includes a simulation unit 28 therein, and causes the simulation unit 28 to perform simulation to verify performance. FIG. 23(b) is the configuration diagram in a case where simulation is performed outside the vehicle. Here, “outside the vehicle” means a calculation resource other than a self-vehicle, such as a cloud, multi-access edge computing (MEC), a roadside machine, or another vehicle. The performance verification unit 26 communicates with the simulation unit 28 installed outside the vehicle, via wireless communication or the like, and transmits necessary settings to the simulation unit 28. The performance verification unit 26 then instructs the simulation unit 28 to perform simulation, and receives a result from the simulation unit 28.

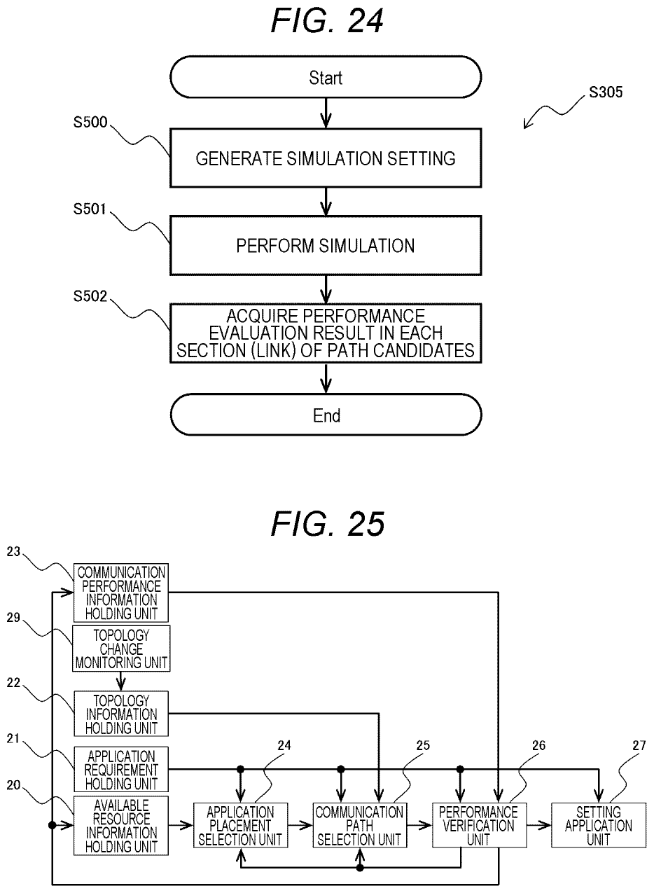

FIG. 24 is a flowchart showing an operation in step S305 in FIG. 16 in the operation of the performance verification unit 26 in the second embodiment. First, in step S500, simulation settings are created. Next, in step S501, the simulation unit 28 is operated to perform simulation. Finally, in step S502, a performance evaluation result is acquired for each section (link) of the path candidates from the simulation result. Here, the performance evaluation result includes a communication band, a delay, jitter, a packet discard rate, and the like.

As described above, the invention according to the present embodiment makes it possible to evaluate performance with higher accuracy, and to increase a storage capacity for applications and improve the stability of the application operation.

### Summary

The performance verification unit 26 of the network system according to the present embodiment verifies whether the communication requirements 64 are satisfied in each communication path in the communication path candidate list 110 using simulation based on the communication performance information and the communication requirements 64.

The above-described configuration according to the present embodiment makes it possible to accurately verify whether the communication requirements 64 are satisfied in each communication path in the communication path candidate list 110.

Further, in a performance verification step of a network management method according to the present embodiment, a verification is made whether the communication requirements 64 are satisfied in each communication path in the communication path candidate list 110 with simulation based on the communication performance information and the communication requirements 64 using a calculator inside the vehicle. This makes it possible to perform the simulation even in an environment where the network system cannot communicate with the outside.

Further, in the performance verification step of the network management method according to the present embodiment, a verification is made whether the communication requirements 64 are satisfied in each communication path in the communication path candidate list 110 with simulation based on the communication performance information and the communication requirements 64 using a calculator outside the vehicle. This makes it possible to improve the accuracy of the simulation because resources for performing the simulation are not limited.

### Third Embodiment

In the first and second embodiments, the topology of the in-vehicle network is assumed to be fixed. On the other hand, the topology of the in-vehicle network may change because of addition of a new device to the CAN, a communication interruption caused by hardware abnormality, or the like. Therefore, in the third embodiment, an in-vehicle network system capable of following such a topology change will be described.

FIG. 25 is a functional block diagram of the in-vehicle network system according to the third embodiment. Compared with FIG. 3, a topology change monitoring unit 29 is added.

The topology change monitoring unit 29 monitors the state of the in-vehicle network using “bus failure” or “error state” in the CAN, and using a method such as Link Level Discovery Protocol (LLDP) in the Ethernet. Here, the state of the in-vehicle network means whether the link on the in-vehicle network is in a normally communicable state. No operation is performed in the normal state. In a case where an abnormality is detected, the link information is deleted or marked as an abnormal state on the topology information table 70 of the topology information holding unit 22, and is not used. Thereafter, the applications including the placed applications are placed again. That is, the communication path selection unit 25, the performance verification unit 26, and the setting application unit 27 are operated to set the application placement and the communication path avoiding the link in the abnormal state.

### Summary

The network system according to the present embodiment further includes the topology change monitoring unit 29 that detects a topology change of the network and notifies the topology information holding unit 22 of the detected topology change.

The above configuration according to the present embodiment makes it possible to place the application in the arithmetic devices 3 and 9 to satisfy the execution requirements 53 and the communication requirements 64 even in a case where the topology of the network changes.

### Fourth Embodiment

In the first and second embodiments, in a case where a plurality of applications is added by OTA, the addition order of the applications is not considered. Therefore, an application added earlier might consume resources inside the ECU and communication resources between the ECUs, and an application to be added later cannot be added. For this reason, in a case where precedence varies among applications, a high-precedence application is not added.

Therefore, the fourth embodiment will describe an apparatus that places an application in consideration of the precedence between the applications.

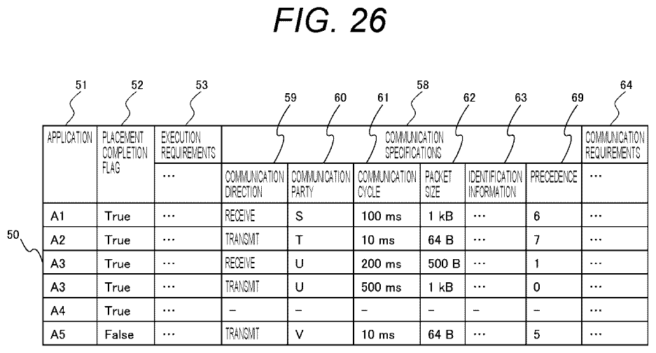

FIG. 26 is the application requirement table 50 held by the application requirement holding unit 21 according to the fourth embodiment. A difference from the first to third embodiments is that a precedence column 69 is added to the communication specifications 58. In FIG. 26, the precedence is set to eight levels between 0 to 7, where 0 is the lowest precedence and 7 is the highest precedence. Since the execution requirements 53 and the communication requirements 64 are identical to those in the first and third embodiments, description of the individual columns is omitted.

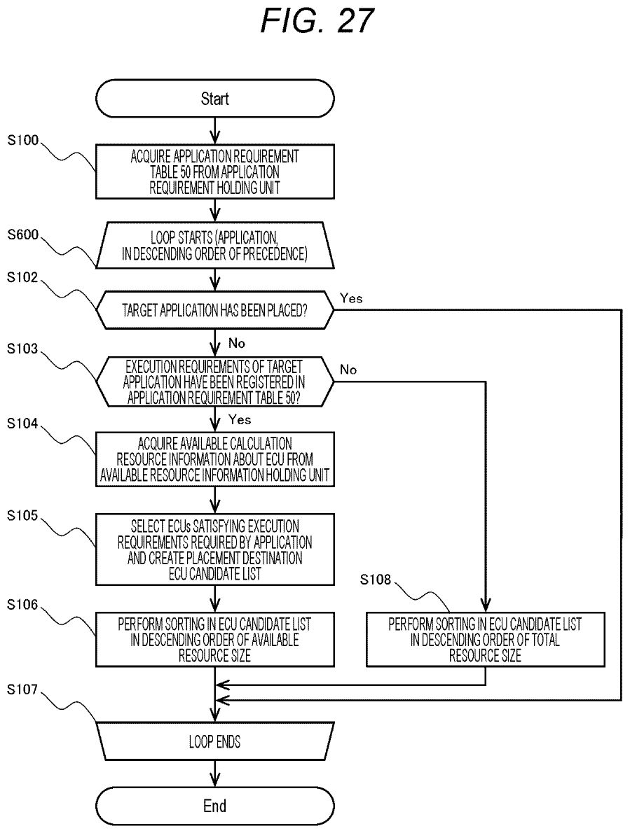

FIG. 27 is a flowchart illustrating an operation of the application placement selection unit 24 according to the fourth embodiment. The same numbers are assigned to the same processing as those of the flowchart (FIG. 9) in the first embodiment. The difference from the first to third embodiments is only that the loop processing in step S101 is changed to in step S600. In step S600, the loop regarding the application is performed in descending order of the precedence in the application requirement table 50 in the present embodiment. As a result, the ECU placement and the communication path are determined earlier for applications with higher precedence.

### Summary

The application requirement holding unit 21 in the present embodiment holds precedence for each application. The application placement selection unit 24 creates the application placement destination arithmetic device candidate list 90 in descending order of precedence of applications.

The above configuration according to the present embodiment makes it possible to place the applications in the arithmetic devices 3 and 9 in descending order of precedence.

### Fifth Embodiment

In the first to fourth embodiments, each item of the communication requirement is treated based on the same precedence, but the degree of satisfaction of the requirement may vary between the communication requirements depending on applications. Therefore, the fifth embodiment will describe a configuration where the communication requirement to be particularly satisfied can be designated for each application.

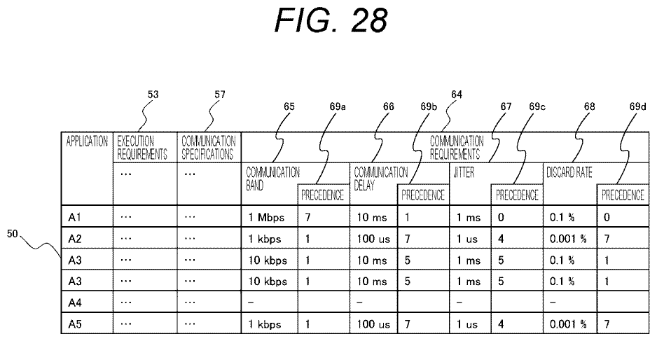

FIG. 28 is the application requirement table 50 held by the application requirement holding unit 21 according to the fifth embodiment. A difference from the first to fourth embodiments is that precedence columns 69a to 69d for respective items of the communication requirement are added. In FIG. 28, the precedence is set to eight levels between 0 to 7, where 0 is the lowest precedence and 7 is the highest precedence. By using the precedence for the respective items of the communication requirement, the applications can be placed to satisfy the communication requirement to be particularly satisfied for the respective applications.

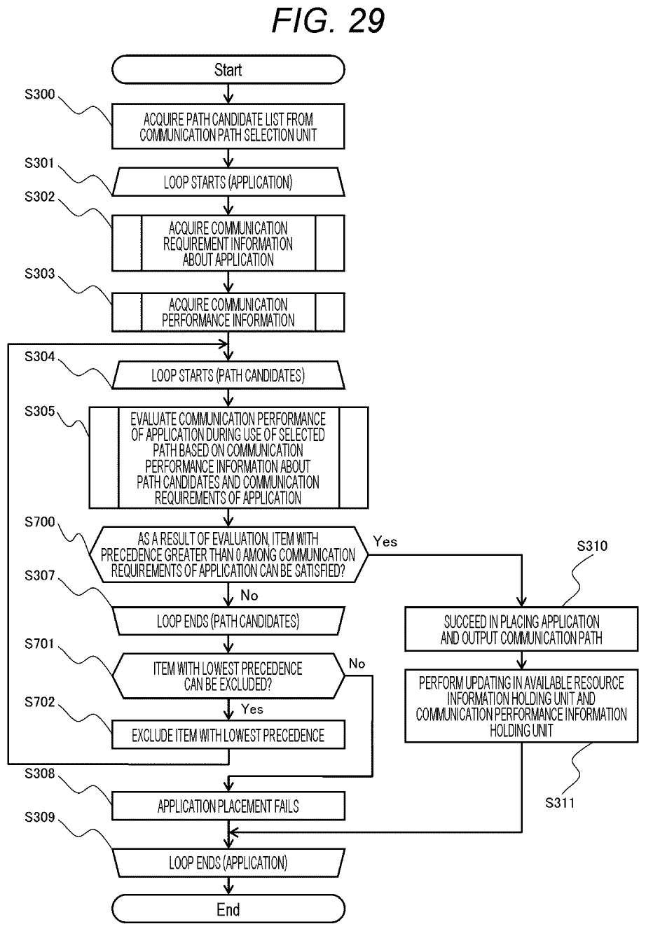

FIG. 29 is a flowchart showing an operation of the performance verification unit 26. The same numbers are assigned to the same processing as those of the flowchart (FIG. 16) in the first embodiment. A difference from the first embodiment is that step S306 is changed to step S700, and the application placement is not failed in step S308 immediately after step S307 ends, but the application placement is attempted again after the item with the lowest precedence is excluded from the communication requirement in steps S700 and S701.

In step S700, as a result of evaluating the application communication performance, a determination is made whether the communication performance of the application can satisfy the communication requirement with preference higher than 0. In a case where the requirement is satisfied (Yes), that is, the application placement succeeds, step S310 and the subsequent steps are executed. In a case where the requirement is not satisfied (No), the loop for the path candidate list ends in step S307.

In step S701, the precedence of the communication requirement of the applications is checked in the application requirement table 50. In a case where the precedence has a value larger than 0 in two or more communication requirements, a determination is made that the communication requirement having the lowest precedence among the communication requirements having precedence larger than 0 can be excluded. In a case where the determination is made in step S701 that exclusion is possible (Yes), in step S702, the precedence of the communication requirement determined to be able to be excluded in step S700 is overwritten with 0. In a case where the determination is made in step S701 that exclusion is impossible (No), the processing proceeds to step S308 and the application placement is regarded to fail.

As described above, the requirement to be particularly satisfied among the communication requirements can be designated, and the application placement satisfying the requirement can be implemented.

### Summary

The application requirement holding unit 21 in the present embodiment holds the precedence for each item of the communication requirements 64 of each application. The performance verification unit 26 excludes an item having the lowest precedence from the communication requirements 64 and verifies again whether the communication requirements 64 are satisfied in a case where one or more unsatisfied items in the communication requirements 64 are present.

The above configuration according the present embodiment makes it possible to place more applications in the arithmetic devices 3 and 9 by excluding an item with low precedence from the communication requirements 64 of each application.

Although the embodiments of the present invention have been described in detail above, the present invention is not limited to the above-described embodiments, and includes various modifications. For example, the above-described embodiments have been described in detail for easy understanding of the present invention, and the present invention is not necessarily limited to those having all the described configurations. Further, a part of the configuration of a certain embodiment can be added to the configuration of another embodiment, a part of the configuration of the certain embodiment can be deleted, or replaced with a part of the configuration of the another embodiment.

### REFERENCE SIGNS LIST

1 vehicle
2 gateway
3, 3a to 3d domain ECU (arithmetic device and in-vehicle electronic control apparatus)
4, 4a to 4d sensor
5, 5a to 5d actuator
6, 6a to 6d link
7 TCU
8 central ECU (arithmetic device and in-vehicle electronic control apparatus)
9, 9a to 9d zone ECU (arithmetic device and in-vehicle electronic control apparatus)
10 shared link
11 CPU
12 memory
13 network switch
20 available resource information holding unit
21 application requirement holding unit
22 topology information holding unit
23 communication performance information holding unit
24 application placement selection unit
25 communication path selection unit
26 performance verification unit
27 setting application unit
28 simulation unit
29 topology change monitoring unit
30 in-ECU available resource information table
31 ECU column
32 calculation resource column
33 storage resource column
34 specification column
40 OTA data
41 header
42 application data
43 metadata
50 application requirement table
51 application column
52 placement completion flag
53 execution requirement
54 communication ID
55 calculation resource column
56 storage resource column
57 specification column
58 communication specification
59 communication direction column
60 communication party column
61 communication cycle column
62 packet size column
63 identification information about application
64 communication requirements
65 communication band column
66 communication delay column
67 jitter column
68 discard rate column
69, 69a to 69 d precedence column
70 topology information table
71 link column
72 type column
73 connection information column
80 communication performance information table
81 link column
82 communication direction
83 total band column
84 band column
85 delay time column
86 jitter column
87 discard rate column
88 buffer usage column
90 application placement destination ECU candidate list (application placement destination arithmetic device candidate list)
91 application column
92 placement destination ECU candidate
100 search list
101 phase
102 communication path candidates
103 state
110 communication path candidate list
111 application column
112 communication path candidates
120 communication path list
121 application column
122 communication path
130 communication path setting table
131 ECU column
132 identification information about application
133 transfer destination ECU

1. A network system where an application is placed in any of a plurality of arithmetic devices existing on a network to satisfy execution requirements of the application, the network system comprising:
an application requirement holding unit that holds the execution requirements and communication requirements of the application;
an available resource information holding unit that holds available resource information about the plurality of arithmetic devices;
an application placement selection unit that selects an arithmetic device capable of executing the application among the plurality of arithmetic devices based on the execution requirements and the available resource information, and creates an application placement destination arithmetic device candidate list;
a topology information holding unit that holds topology information indicating a communication connection relationship of the plurality of arithmetic devices;
a communication performance information holding unit that holds communication performance information about links of the network;
a communication path selection unit that selects a communication path of the application in a case where the application is placed in each arithmetic device in the application placement destination arithmetic device candidate list and creates a communication path candidate list based on the topology information;
a performance verification unit that verifies whether the communication requirements are satisfied in each communication path in the communication path candidate list based on the communication performance information and the communication requirements; and
a setting application unit that places the application in an arithmetic device corresponding to a communication path having the communication requirements verified to be satisfied by the performance verification unit among the arithmetic devices in the application placement destination arithmetic device candidate list.

2. The network system according to claim 1, wherein the communication requirements and the communication performance information include any one or more of a communication band, a communication delay, communication jitter, and a packet discard rate of the application.

3. The network system according to claim 1, wherein the performance verification unit verifies whether the communication requirements are satisfied in each communication path in the communication path candidate list, by numerical calculation based on the communication performance information and the communication requirements.

4. The network system according to claim 1, wherein the performance verification unit verifies whether the communication requirements are satisfied in each communication path in the communication path candidate list, by simulation based on the communication performance information and the communication requirements.

5. The network system according to claim 1, further comprising a topology change monitoring unit that detects a topology change of the network and notifies the topology information holding unit of the detected topology change.

6. The network system according to claim 1,
wherein the application requirement holding unit holds precedence for each application, and
wherein the application placement selection unit creates the application placement destination arithmetic device candidate list in descending order of the precedence.

7. The network system according to claim 1,
wherein the application requirement holding unit holds precedence for items of the communication requirements, and
wherein the performance verification unit excludes an item having lowest precedence from the communication requirements and verifies again whether the communication requirements are satisfied in a case where one or more unsatisfied items in the communication requirements are present.

8. The network system according to claim 1, wherein metadata to be input to the network together with the application when the application is placed includes
the execution requirements including any one or more of a calculation resource, a storage resource, and specifications,
the communication specifications including any one or more of a communication direction, a communication party, a communication cycle, a communication data size, and communication identification information, and
the communication requirements including any one or more of a communication band, a communication delay, communication jitter, and a packet discard rate.

9. The network system according to claim 1,
wherein the network is an in-vehicle network mounted on a vehicle, and
wherein the plurality of arithmetic devices is a plurality of in-vehicle electronic control apparatuses mounted on the vehicle.

10. An in-vehicle apparatus comprising the network system according to claim 9.

11. The network system according to claim 9, wherein the communication requirements include items related to sensor data output from a sensor mounted on the vehicle, control data for controlling the vehicle, and intermediate data acquired during arithmetic for obtaining the control data from the sensor data.

12. A network management method for placing an application in any one of a plurality of arithmetic devices existing on a network to satisfy execution requirements of the application, the network management method comprising:
holding the execution requirements and communication requirements of the application;
holding available resource information about the plurality of arithmetic devices;
selecting an arithmetic device capable of executing the application among the plurality of arithmetic devices based on the execution requirements and the available resource information, and creating an application placement destination arithmetic device candidate list;
holding topology information indicating a communication connection relationship of the plurality of arithmetic devices;
holding communication performance information about links of the network;
selecting a communication path of the application in a case where the application is placed in each arithmetic device in the application placement destination arithmetic device candidate list and creating a communication path candidate list based on the topology information;
verifying whether the communication requirements are satisfied in each communication path in the communication path candidate list based on the communication performance information and the communication requirements; and
placing the application in an arithmetic device corresponding to a communication path having the communication requirements verified to be satisfied in the verification of the performance among the arithmetic devices in the application placement destination arithmetic device candidate list.

13. The network management method according to claim 12,
wherein the network is an in-vehicle network mounted on a vehicle, and
wherein the plurality of arithmetic devices is a plurality of in-vehicle electronic control apparatuses mounted on the vehicle.

14. The network management method according to claim 13, wherein in the performance verification, a verification is made whether the communication requirements are satisfied in each communication path in the communication path candidate list, by simulation using a calculator inside the vehicle based on the communication performance information and the communication requirements.

15. The network management method according to claim 13, wherein in the performance verification, a verification is made whether the communication requirements are satisfied in each communication path in the communication path candidate list by simulation using a calculator outside the vehicle based on the communication performance information and the communication requirements.
